(19) United States
(12) Patent Application Publication
(10) Pub. No.: US 2006/0014132 A1
(43) Pub. Date: Jan. 19, 2006

(54) Teaching easel with electronic capabilities

(76) Inventor: Johnny Hamilton, Los Angeles, CA (US)

Correspondence Address: DAVID CHEN;DWC LAW FIRM, P.S., P.O. BOX 3041, SEATTLE, WA, 98114-3041, US

(21) Appl. No.: 11/096,329

(22) Filed: Apr. 2, 2005

Related U.S. Application Data
(60) Provisional application No. 60/589,106, filed on Jul. 19, 2004.

(51) Int. Cl. G09B 25/00

(52) U.S. Cl. 434/365

(57) ABSTRACT

A teaching easel having a display screen and a projector, and one or more multimedia devices or systems communicatively coupled thereto. Also, reflective surfaces can be provided within a compartment of the teaching easel to reflect images from the projector onto the display screen. The display screen can be interactive and responsive to user inputs via contact therewith or movement near a surface thereof.

### CROSS-REFERENCE TO RELATED APPLICATION(S)

This application claims the benefit of U.S. Provisional Patent Application No. 60/589,106 filed Jul. 19, 2004, which is incorporated herein by reference in its entirety.

### BACKGROUND OF THE INVENTION

1. Field of the Invention

The following invention relates to teaching easels with electronic capabilities.

2. Description of the Related Art

Elementary school teachers often instruct classes through the use of various instructional tools. Examples include teaching easels equipped with one or more conventional display boards (e.g., whiteboard) that may be written or drawn upon using, for example, erasable markers. Using the display board allows a teacher to display to a plurality of students simultaneously. Such easels are also often equipped with a ledge below the display board upon which writing utensils can be placed. Also, “big books” are sometimes placed on the ledge. “Big books” typically have enlarged text to allow a plurality of students to be able to see and read the text simultaneously from different areas in a classroom. Other examples of instructional tools, to name a few, include audiotape players, CD players, DVD players, televisions, VCRs, overhead projectors, chart papers and stands, sentence strip charts, calendar charts, number charts and flash cards.

Instruction incorporating all or some of the myriad of available teaching tools can require stand-alone apparatus and systems, storage space and generally independent management of each tool. It is also notable that there are some excellent tools (e.g. Internet, CD-ROM based programs, etc.) that are typically not used for classroom instruction because there is no convenient way to do so. There is a need for a more convenient and efficient way to make use of various instructional tools for schoolteachers and to be able to save, retrieve and modify notes, graphics, video and files used during instruction.

### BRIEF DESCRIPTION OF SEVERAL VIEWS OF THE DRAWINGS

FIG. 1A is a perspective view of an embodiment of the teaching easel of the present invention.

FIG. 1B is a close up partial perspective view of a slidable support surface for an embodiment of the present invention.

FIG. 1C is a perspective view of an embodiment of the teaching easel of FIG. 1A further showing a removable non-electronic writing or display board that can be removably placed over the display surface of the teaching easel of FIG. 1A.

FIG. 2 is side elevation view of the teaching easel of FIG. 1A.

FIG. 3 is a front elevation view of the teaching easel of FIG. 1A.

FIG. 4 is a perspective view of another embodiment of a teaching easel of the present invention.

FIG. 5 is a perspective view of the embodiment of the invention in FIG. 4, further showing a camera and a side support member below the camera.

FIG. 6 is a perspective view of the embodiment of the invention in FIG. 4, further showing various components of the teaching easel disposed in an interior compartment thereof.

FIG. 7 is a perspective view of the embodiment of the invention in FIG. 4, showing a back-side of the teaching easel having a display board, such as a whiteboard or digital whiteboard.

FIG. 8 is a simplified cutaway side elevation view of the embodiment of the invention in FIG. 4, showing various components disposed within the internal compartment.

FIG. 9 is a side cross-section view of the screen for the teaching easel in some embodiments of the present invention, such as the embodiment in FIG. 4.

FIG. 10 is a partial perspective view of another embodiment of the projection screen for some embodiments of the present invention.

FIG. 11 is a perspective view of an embodiment of the teaching easel of the present invention having a retractable camera disposed proximate a top portion of the teaching easel.

### DETAILED DESCRIPTION OF VARIOUS EMBODIMENTS OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known structures associated with traditional-type teaching easels have not been described in detail to avoid unnecessarily obscuring the descriptions of the embodiments of the invention.

The term “multimedia device” as used herein refers to, inter alia, any of the myriad of electronic devices commercially available that are capable of displaying or providing a signal for the display of text, graphics, animation, audio or video, or any combination thereof, including, without limitation, any computer or media center having computing capabilities. The term “conventional display board” as used herein refers to non-electronic boards typically used by instructors or teachers for displaying pictures or text to an audience, such as, for example, without limitation, whiteboards commonly used with erasable markers. The terms above are to be construed as has been defined unless the context indicates otherwise.

Various embodiments of the present invention are described in the context of teaching students in classrooms. However, one skilled in the art will appreciate after reviewing the present disclosure, that the present invention is not limited to the context of school. Indeed, the present invention may have applicability in many contexts where a user has the need for multiple communication tools in combination with the need to display to more than one individual at a time.

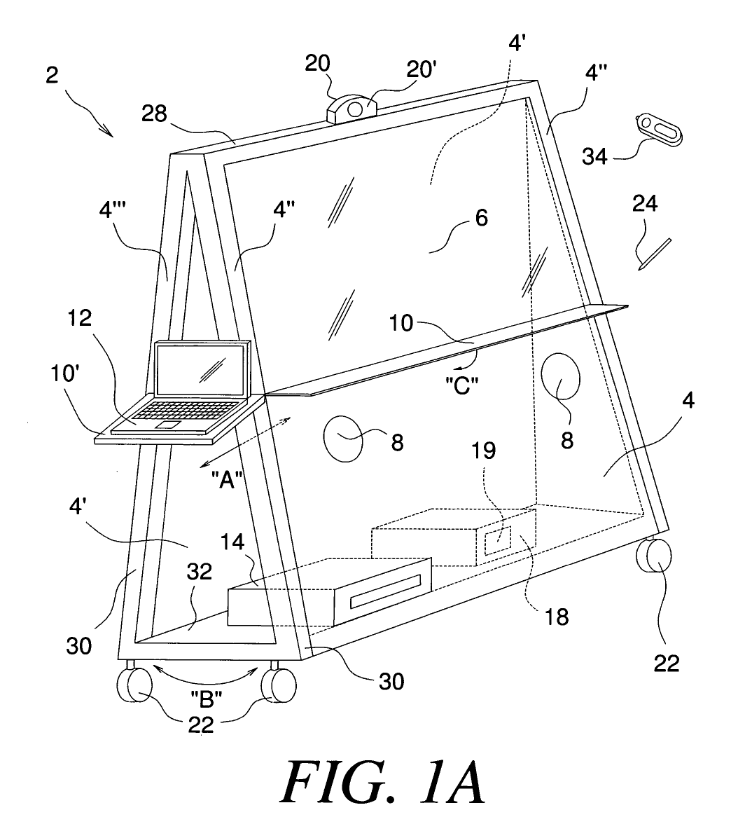

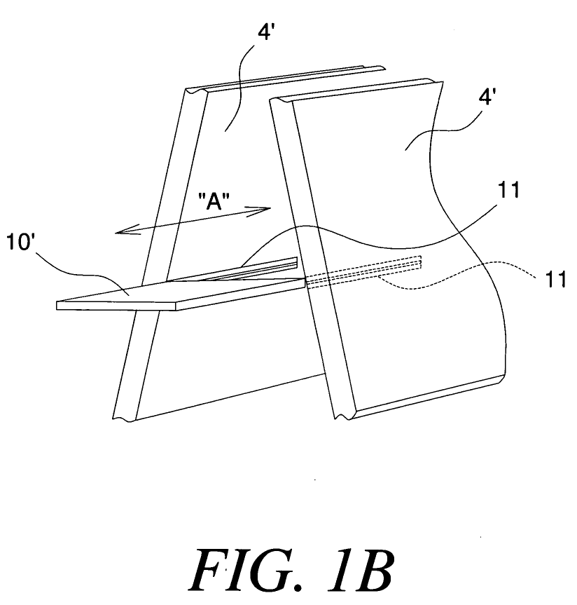

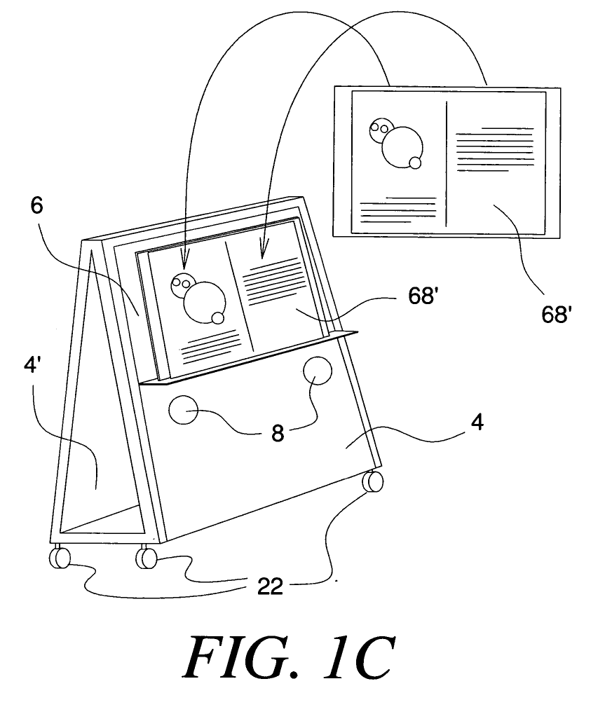

In some embodiments of the present invention a teaching easel 2 is provided having two panels, a front panel 4 and a back panel 4′, as best seen in FIGS. 1A & 2. In some embodiments, the panels 4, 4′ include front frame members 4″ and back frame members 4″′. The panels 4, 4′ can be joined together along their upper edge portions 28, or spaced apart. In other embodiments, an additional joining member or joining panel (not shown) can be disposed between the upper edge portions 28 of the panels 4, 4′. As will be appreciated by one skilled in the art after reviewing this disclosure, the additional joining panel (not shown) can be provided in embodiments where more space is required between the front panel 4 and back panel 4″.

Again referring to FIG. 1A, a bottom panel 32 can be coupled between lower edge portions 30 of the front and back panels 4, 4′. In some embodiments, the upper edge portions 28 of the front and back panels 4, 4′ may be pivotally joined together (a pivotable joint is not shown in the illustrations) so that the lower edge portions 30 thereof can be inwardly collapsible or outwardly expandable with respect to one another, as best illustrated by arrow “B” in FIG. 1A. This allows for reducing the space requirements of the teaching easel 2 during storage. In such collapsible/expandable embodiments, the bottom panel 32 may be completely removable or foldable against the front panel 4 or back panel 4′. Furthermore, transporting members such as wheels or casters 22 may be removably or permanently mounted to the teaching easel to facilitate transporting the teaching easel 2.

One or more of the panels 4, 4′ may incorporate a display surface 6, such as a projection screen capable of display images from an LCD projector 18. In some embodiments, the display surface 6 is only present on one of the panels, such as the front panel 4. Also, ledges or support surfaces 10, 10′, 10″ may be removably or permanently affixed to the panels 4, 4′, or frame members 4″, 4′″ extending outwardly therefrom. In other embodiments, one or more of the support surfaces 10, 10′, 10″ may be slidably connected to the teaching easel 2. For example, in some embodiments the side support surfaces 10′ or 10″ can be slidably attached to front and back panels 4, 4′ so as to be capable of being slid between those panels in the directions indicated by arrow “A” in FIG. 1A. A simplified diagram showing structural elements, such as a track 11, for allowing the support surfaces 10′, 10″ to be slidable with respect to the panels 4, 4′ is illustrated in FIG. 1B, as will be appreciated by one skilled in the art after reviewing this disclosure. In other embodiments, the support surfaces 10, 10′, 10″ can be folded inward toward one of the front or back panels 4, 4′ in the direction of arrows “C”, or “D′” for reducing space requirements when needed. See FIGS. 1A & 2. In such embodiments, releasable locking mechanisms (not shown) can be employed to releasably lock the support surfaces 10, 10′, 10″ in an extended position, such as the extended positions illustrated in FIG. 1A. The foldable or slidable features of the support surfaces 10, 10′, 10″ can be used to reduce space requirements during storage of the easel 2, or when one or more the support surface 10, 10′, 10″ are not in use.

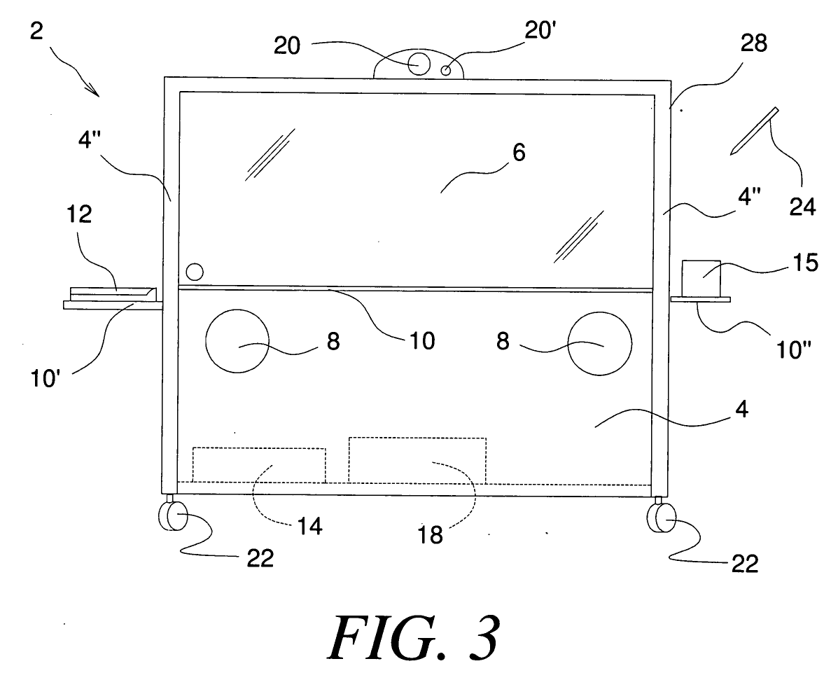

In the illustrated embodiments, a computer 12, which can be a laptop, is shown resting on a side support surface 10′ with front support surface 10 extending outwardly away from the front panel 4. In other embodiments, a second side support surface 10″ can be provided. See FIG. 3. The second side support surface 10″ can be used to support various other devices usable with the present invention, such as, for example, a document camera 15 or microscope (discussed further, infra).

The teaching easel 2 may also incorporate one or more multimedia or media devices 14, including but not limited to a computer, VCR, a DVD player, a digital video recorder, an audiotape player, a CD player, a receiver for broadcast, cable or satellite television signals, and an Internet or global network communication device and system that may comprise a computer 12 that can also be capable of reading and executing programs from a computer readable medium. Multimedia device 14 can be any one of the aforementioned media devices or a combination thereof. The teaching easel may also have one or more telecommunication input/receiving devices, such as a video camera 20, microphone 20′ or both. The video camera 20 and microphone 20′ may be digital or analog and may be integrated together within a single device. Also, the video camera 20 or microphone 20′ may be controlled through the computer 12.

Given the multimedia capabilities of the illustrated embodiments, audio speakers 8 can be coupled to the various multimedia systems or devices 14, 12 usable with the present invention and may be mounted or integral to the teaching easel 2, such as being coupled to the front panel 4, as best seen in FIG. 1A. The audio speakers 8 may receive wired or wireless signals from, for example, the computer 12, or one of the other aforementioned multimedia devices. Some acoustic parameters of the audio speakers 8 may be controlled through one or more of the multimedia devices 14, or the computer 12, and those devices themselves may also comprise remote controllers 34 that are wireless or wired to the corresponding multimedia device 14.

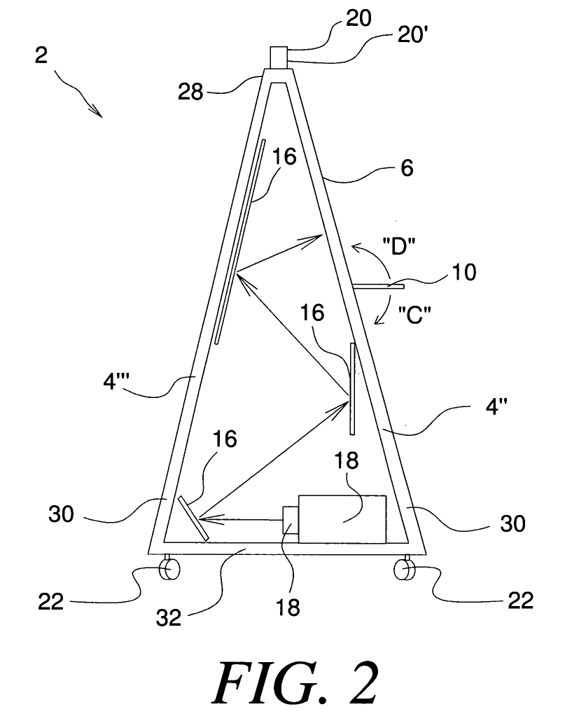

Again, each of the aforementioned multimedia devices 14 can be combined into a single multimedia device 14 or distributed in various devices with combined or singular capabilities, as will be appreciated by one skilled in the art after reviewing the present disclosure. However, to facilitate simplicity in illustration and to avoid unnecessarily obscuring the descriptions of the embodiments of the invention, only one computer 12 (which is a laptop in the illustrated embodiment) and an additional multimedia device 14 are illustrated in the FIGS. 1A, 2, & 3. Multimedia devices can comprise the computer 12, as is implicit throughout this disclosure.

In some embodiments, a projector 18, such as an LCD projector, is provided for projecting images received from one of the various multimedia devices 14 onto the display surface 6. In these embodiments, the projector 18 can be disposed or mounted on the base panel 32. Also, reflective surfaces 16 can be provided to reflect projected images from the projector 18 to the display surface 6, as best seen in FIG. 2. Various operating variables for the projector 18, such as on/off, brightness, position adjustments and color control may be adjusted by any one of a plurality of control devices remotely or proximately positioned with respect to the projector 18, or coupled to a surface of the projector 18 (e.g., projector control panel 19). For example, in some embodiments, the projector 18 is controlled by a computer 12 or a wireless or wired remote control device 34, as shown in FIG. 1A, and in other embodiments the projector 18 may be controlled through the computer 12 or a proximately located control panel 19, also shown in FIG. 1A. The control panel 19 of the projector 18 may be accessible through a port (not shown) located on the front panel 4 or back panel 4′, in some embodiments.

In other embodiments, the display surface 6 may be configured to directly display images or content without projection from a projector 18, such as, for example, where the display surface is itself a flat panel screen (e.g., LCD or plasma screen). In such embodiments, the display surface 6 may receive wireless electromagnetic signals from, or be coupled to one or more multimedia/media devices 14 via electrical wiring. In either case, the display surface 6 may be used to display content and images from Internet websites, multimedia CD-ROMs, and other images or content delivered through the computer 12 or any of the other aforementioned multimedia devices 14.

In some embodiments, the display surface 6 itself may be interactive and capable of receiving signals provided by a user. For example, in some embodiments, the display surface 6 comprises a touch sensitive screen, capable of receiving input by direct physical contact by a user's hand or non-mechanical stylus. In other embodiments, a transmitting stylus is provided as an input device, which can provide input to the computer 12 or other various multimedia devices 14 by pointing the stylus at various locations on the display surface 6. The stylus transmits signals to a receiver located on the display surface 6, which sends information to the computer 12. As will be appreciated by one skilled in the art after reviewing this disclosure, these various technologies using touch sensitive screens responsive to input via direct physical contact or input via contact with a transmitting stylus and receiver, currently exist and are capable of being incorporated with the present invention. In other embodiments, there is another display surface 6′ (not shown) disposed on the back panel 4′.

A teacher may use the teaching easel 2 in some traditional manners. For example, teaching easel 2 has some traditional mechanical benefits, such as an upright display board and support surfaces that can be used to hold pens, “big books” or other physical hardcopy displayable items such as pictures, flash cards, artwork, etc. In addition, in some embodiments, the teacher can write characters in erasable marker directly on a display surface 6 or 6′.

At the same time, the various embodiments of the invention disclosed provide unique advantages over the current state of the relevant art, including integrating various multimedia devices within a single teaching device that has new combined mechanical advantages. The combination provides for various new methods of teaching or instruction. The teacher may use the teaching easel 2 to display a computer-based application on the display surface 6 (such as, without limitation, KIDSPIRATION or DVD encyclopedia). Furthermore, in some embodiments, the teacher or a student may draw or write on the display surface 6 (with a stylus or by direct touch as described above for various embodiments disclosed, supra) and the input text and graphics thereby may be created, saved retrieved and modified directly into the computer 12, or other memory system (not shown). In addition, the telecommunications receiving device 20, 20′ may be used to videoconference, or otherwise communicate, with remote parties, such as with other classrooms, with the display surface 6 and audio speakers 8 displaying video/images and emitting audio received from the other classrooms. This ability can also allow instructors to incorporate outside instruction, guest speakers, or the like into their teaching curriculum, by allowing classroom participants to videoconference with the outside party through the teaching easel 2. As will be appreciated by one skilled in the art after reviewing this disclosure, in such instances, the multimedia devices 14, 12 can comprise various available equipment capable of receiving or transmitting audio/visual signals from and to remote locations through existing infrastructure, such as, for example, Internet video or videoconferencing. Signals can be received to local participants using the display surface 6, audio speakers 8 and a multimedia device 14 and signals to be transmitted from the local participants to participants abroad can be broadcast via the video camera 20 and microphone 20′ and other input devices, such as various embodiments of the touch sensitive display surface 6 or through a keypad on the computer 12.

In other embodiments, there is a wireless Ethernet receiving allowing the computer 12 to communicate at high speeds with other computers, to share peripherals (e.g. printers, storage) and files, and to connect to the Internet. The transmitter can be located apart from the teaching easel 2, within transmission range, such as, for example, in the same room or adjacent the rooms within which the teaching easel 2 is residing. The transmitter can be incorporated into a computer network, which includes a connection to the Internet via modem, server or other device.

In still further embodiments, instructors can use the teaching easel 2 to display images via a microscope or document camera 15 onto the display surface 6. Also, the instructor may choose to use some embodiments of the teaching easel 2 to display or broadcast media from computer, digital video recorder, VHS, DVD, CD's, or the Internet to a local audience.

The dimensions of the display surface 6 or 6′ for the teaching easel 2 of the present invention can be approximately four feet wide and three feet tall, similar to traditional rolling type easels, or can be taller, shorter, wider or more narrow, depending on the specific needs of the user. Also, The wheels 22 can be lockable and power cords (not shown) usable with the multimedia devices 14, LCD projector, and any other power supply needs of the teaching easel 2 can be retractable, such as being mounted on spring loaded reels that can automatically retract the power cords upon release of a lock. Connectors or communications ports for USB, Firewire, Ethernet, etc., can be disposed on the front, back and sides of the teaching easel 2.

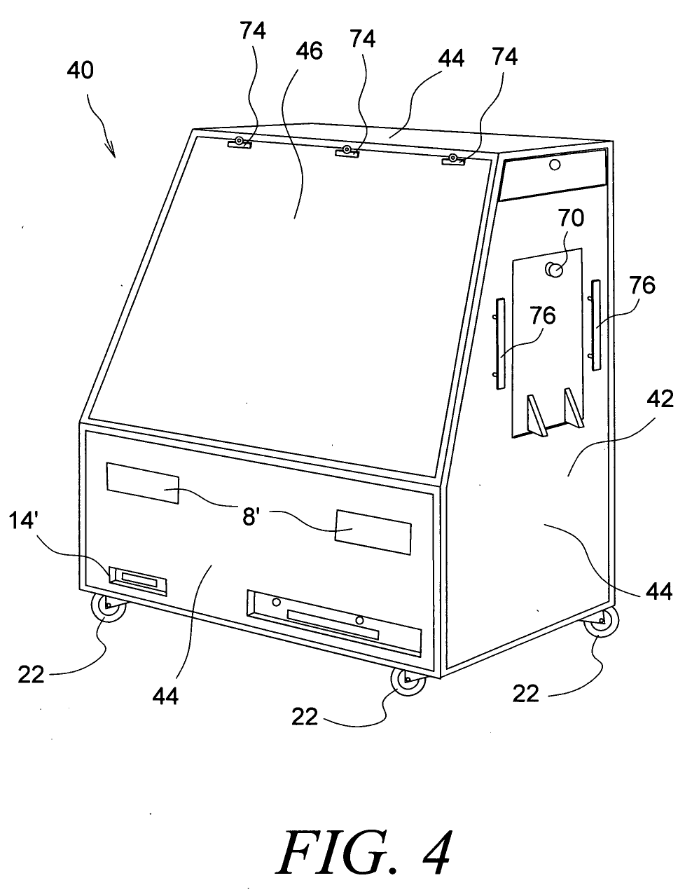

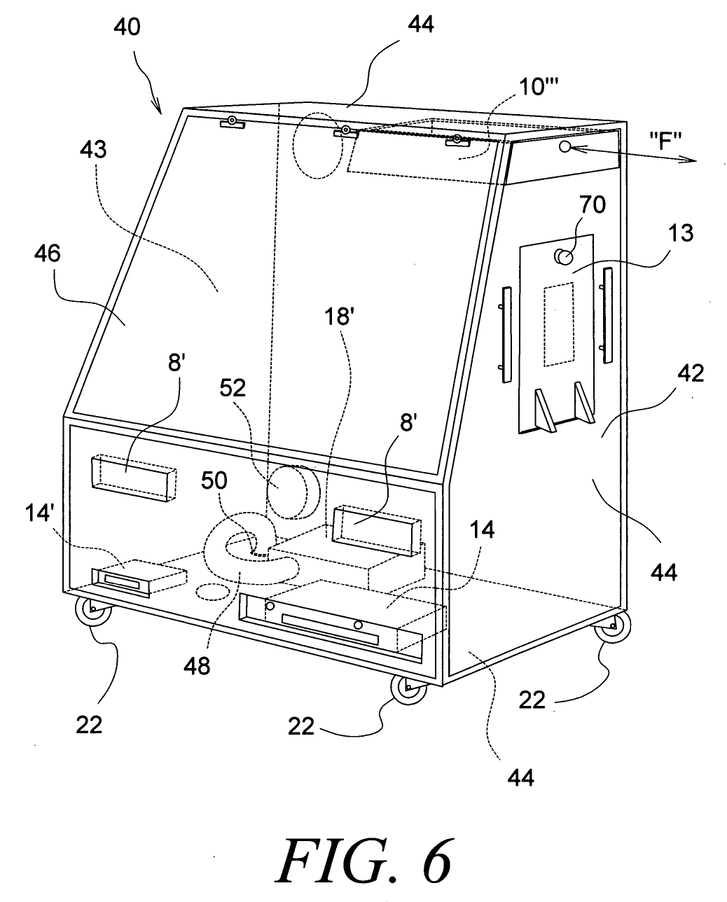

In another embodiment of the present invention, a teaching easel 40 is provided having an internal compartment 43, as best seen in FIGS. 4 and 6. The internal compartment 43 is defined by side, front, back, top and bottom walls 44 and a screen 46.

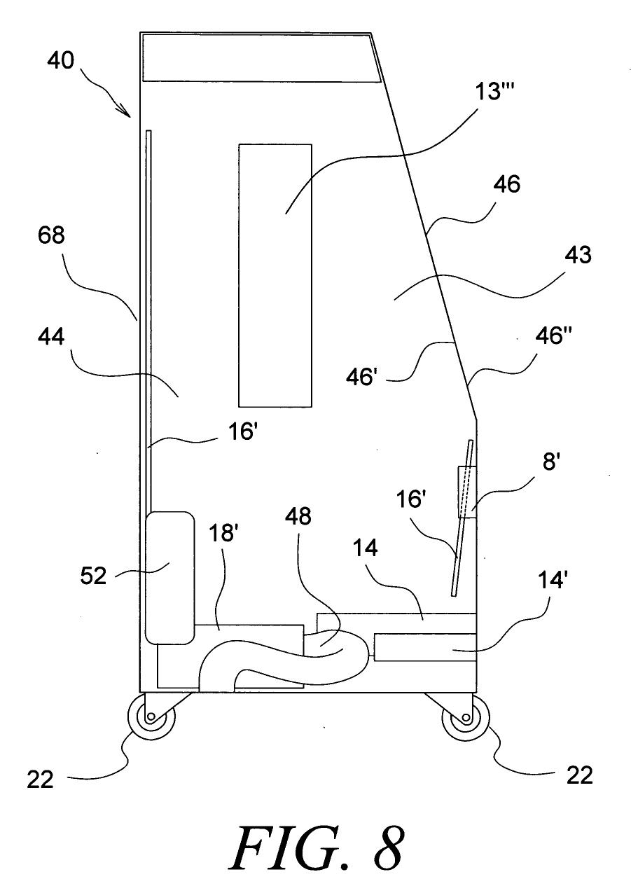

The screen 46 can have rear projection display capabilities. As can be seen in FIG. 8, a projector 18′ (e.g., LCD projector) can be used to project images onto a rear surface 46′ of the screen 46 which is perceivable as an image on a front surface 46″ of the screen 46. The projector 18′ can be disposed within the internal compartment 43. Mirrors 16′, or reflective surfaces, can also be disposed and oriented within the compartment 43 to redirect light emitted from the projector 18′ generally in the direction of the screen 46.

A vent conduit 48 and vent system can also be provided. The vent conduit 48 can be fluidly coupled to the projector 18′ and an opening 50 on a bottom wall of the teaching easel 40, as best seen in FIG. 6. In this way, heat from the projector 18′ can be dissipated out of the internal compartment 43 via convention.

Speakers 8′ can be provided and configured for wired or wireless linking (not shown) to one or more multimedia devices 14 or systems. In the illustrated embodiment in FIG. 6, the speakers 8′ are coupled to a front wall 44 of the teaching easel 40.

The multimedia device 14 shown in FIG. 6 can be a media center in some embodiments. The media center can provide a combination of computing and media capabilities, including, without limitation, recording or playing television broadcasts, radio broadcasts and music, playing pre-recorded videos, displaying or creating slide shows, listening to the radio, serving as an online or network communication device, or operating as a personal computer to execute a myriad of computer activities that could otherwise be implemented with a desktop personal computer or laptop. Example media centers include QMEDIA products by ZT INTERNATIONAL GROUP, INC. As will be appreciated by those skilled in the art after reviewing this disclosure, the media center can be provided with wireless or wired links to a wide array of multimedia devices, including all of those discussed in this disclosure, and can serve as a command or control center for those and other multimedia devices coupled thereto. For example, the media center can be linked to the projector 18′ such that a graphical user interface executed in the media center can be displayed on the screen 46. A user can interact with the graphical user interface, or other software within the media center, to control the variety of other multimedia devices linked to the media center or integral to the media center (e.g., projector 18′, computer 12, VCR 14′, a DVD player, a digital video recorder, an audiotape player, a CD player, a receiver for broadcast, cable or satellite television signals, and an Internet or global network communication device and system). These multimedia devices or systems can be disposed within the internal compartment 43 in some embodiments of the present invention, or be remotely located, or some of the multimedia devices can be disposed within the internal compartment 43 while others are remotely located.

Referring to FIG. 6, a power cord compartment 52 can be provided in the teaching easel 40 to help manage one or more power cords. The power cord compartment 52 can comprise a spring loaded (not shown) retraction system or spool with locking mechanism for locking a power cord (not shown) that is pulled form the compartment in an extended position, or for automatically retracting it when necessary to store the cord, as will be appreciate by those skilled in the art after reviewing this disclosure.

In some embodiments, a slidable support 10″′, best seen in FIG. 6, such as a docking tray, storage compartment or drawer, can be provided for retaining one or more multimedia devices 14, such as a tablet personal computer 92 or other computer 12 (e.g. laptop), or for storing or retaining any of various items, such as items typically utilized by teachers in a class room, like erasable markers, stylus, wireless keyboard or mouse, remote controls for various multimedia devices, or teaching tools or supplies. The slidable support 10″′ can be slid outward away from the teaching easel 40 or inward toward the teaching easel 40, in the directions represented by arrow “F” to slide the support 10″′ into the internal compartment 43, or to expose the slidable support 10″′ so that it may be accessed for retaining items or removing items therefrom. The slidable support 10″′ or drawer may be selectably lockable in some embodiments.

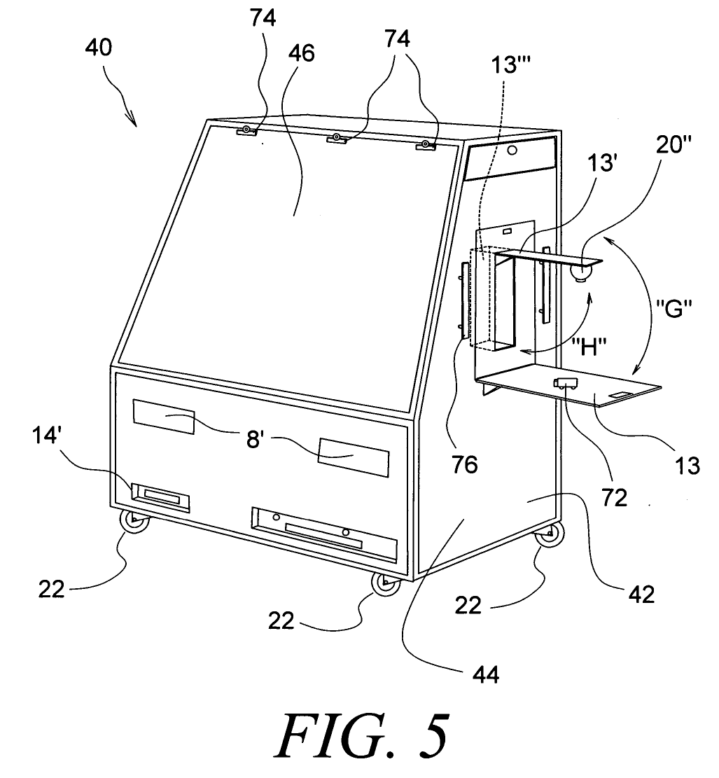

A side support 13 can also be coupled to the teaching easel 40 on a side portion 42 thereof. The side support 13 can be configured to be foldable outward away from the teaching easel 40 to an extended position (such as shown in FIG. 5), or inward toward the teaching easel 40 to a closed position (such as shown in FIG. 4), in the directions illustrated by arrow “G.” In addition, some embodiments have a support arm 13′ on which a camera 20″ is mounted. The camera 20″ can be a digital (or analog camera, in some embodiments), such as a document camera or webcam, capable of sending still image or video signals. The support arm 13′ may also be foldable in the directions illustrated by arrow “H” from an extended position (as shown in FIG. 5) to a closed position (as shown in FIGS. 6 & 8). The support arm 13′ and the side support 13 can be configured such that they overlap one another when folded into closed positions (as shown in FIG. 6), with the side support 13 being on the outside. One or more gripping elements 70, like a handle, can be coupled to the side support 13 or support arm 13′ for a user to grip when folding or unfolding the components to extend or close the components.

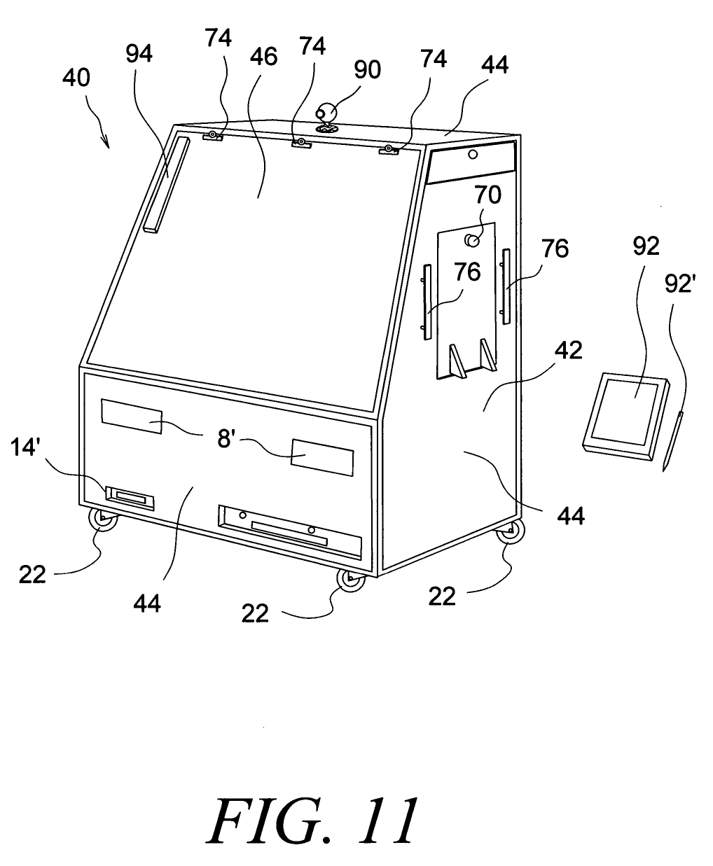

The camera 20″ can be configured to feed signals to the projector 18′. The image received by the camera itself can include an image of a document or other object 72 placed on a surface of the side support 13, as can be seen in FIG. 5. In this manner, the foldable support arm 13′ and side support 13 provide a convenient manner of storing the camera 20″ and side support 13 out of the way of a user when not being utilized, while also providing a quickly accessible assembly and system for use to feed image signals to the projector 18′. Referring now to FIG. 11, in other embodiments, an additional camera 90, such as a webcam or digital video camera, is disposed proximate the top of the teaching easel 40. The additional camera 90 can be retractable such it can be retracted below the top wall 44 of the teaching easel 40 for storage. The location of the additional camera 90 can be convenient for use in video conferencing.

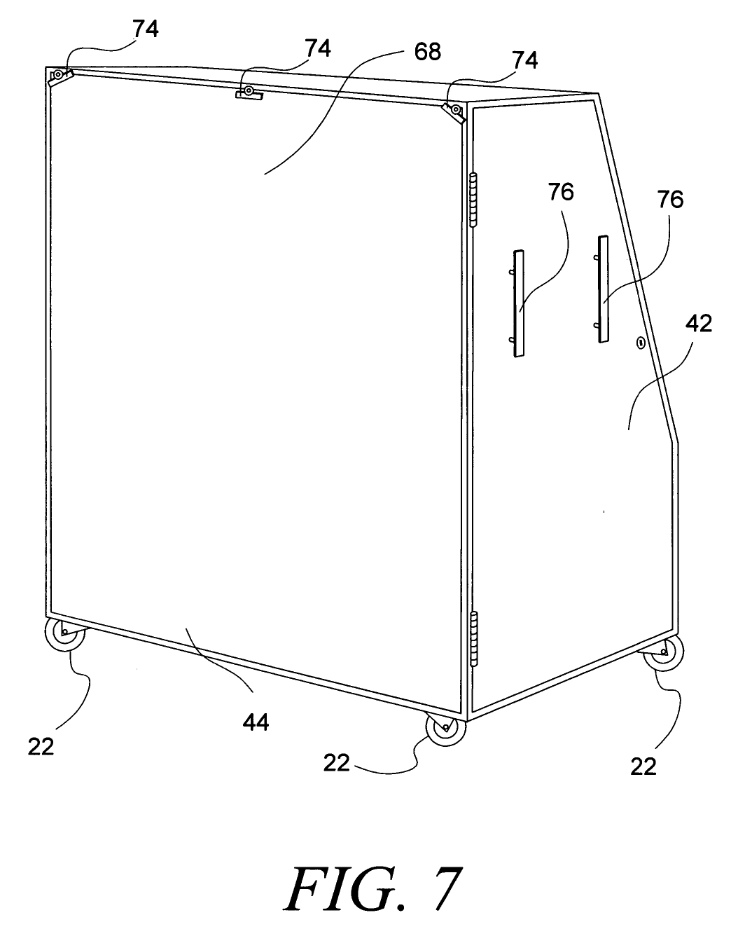

A conventional display board 68, such as a whiteboard or a pegboard, can be coupled to a back wall 44 of the teaching easel 40, as shown in FIG. 7. Clips 74 can be also be coupled to the back wall 44 of the teaching easel 40 or the display board 68. In some embodiments, the clips 74 are magnetic clips that are removably coupled to a metallic portion of the teaching easel 40.

Like some previously described embodiments of the present invention, the embodiment illustrated in FIG. 4 can also be mounted on wheels 22 or casters that may be removably or permanently mounted to the teaching easel 40 to facilitate transporting the teaching easel 40. Handles 76 can also be coupled to the teaching easel 40 for a user to grip when transporting the teaching easel 40. In some embodiments, one or more of the wheels 22, such as the rear wheels proximate the back wall of the teaching easel 40, are selectably lockable, for stabilizing the teaching easel 40 while it is being used.

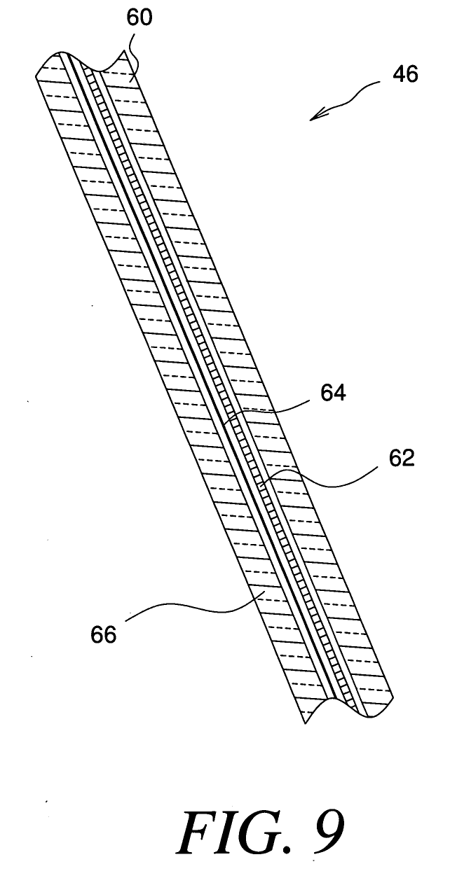

In some embodiments of the present invention, the screen 46 of the teaching easel comprises multiple sections. For example, as best seen in FIG. 9, the screen 46 has an innermost section 66 and an outermost section 60, with each of these sections 60 and 66 comprising a sheet of transparent resinous material, such as, without limitation, PLEXIGLAS by ROHN & HASS COMPANY, U.S.A. A sheet of rear projection fabric 62 can also be disposed adjacent, but inward of, the outermost section 60. Suitable rear projection fabric includes, without limitation, rear projection fabric obtainable from DA-LITE SCREEN COMPANY, INC., of the U.S.A. Also, a frosted privacy film 64 can be adhered to an outer surface of the innermost section 66, as will be appreciated by those skilled in the art after reviewing this disclosure.

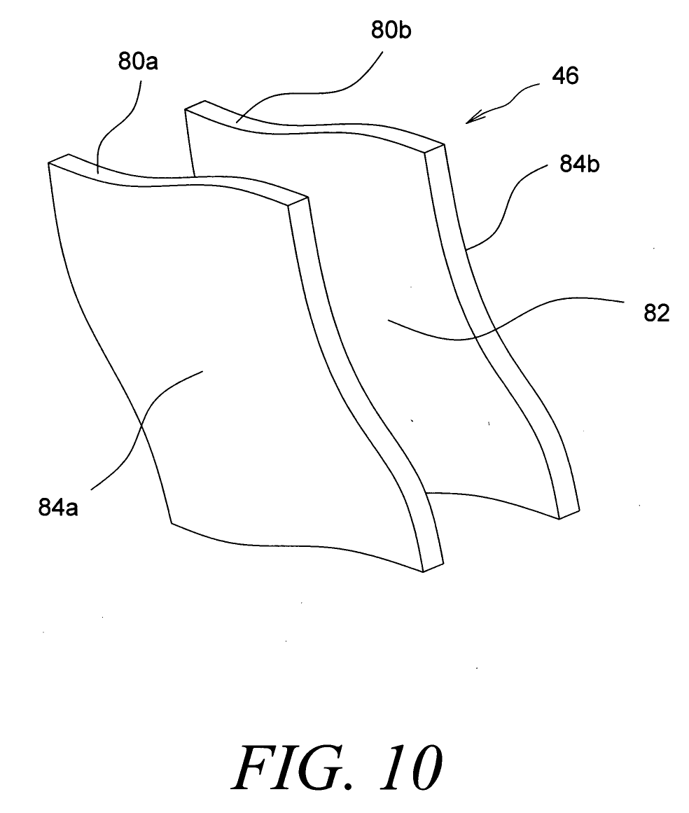

In another embodiment of the screen 46, in which the screen is usable for rear projection, a sheet of transparent resinous material (e.g., PLEXIGLAS by ROHN & HASS COMPANY, U.S.A.) is provided as a rear sheet 80a of the screen, best seen in FIG. 10. In addition, a coated clear acrylic plastic sheet can be provided as a front sheet 80b for the screen 46. In some embodiments, the front sheet 80b can be a DA-LITE POLACOAT type VIDEO VISION screen from DA-LITE SCREEN COMPANY, INC., of the U.S.A. The front sheet 80b can have a coated surface 82. An inner facing surface 84a of the rear sheet 80a can have an antiglare film or coating, as will be appreciated by those skilled in the art after reviewing this disclosure. The inner facing surface 84a can substantially face one of the mirrors 16′ within the internal compartment 43 of the teaching easel 40. An outer facing surface 84b of the front sheet 80b can also have an antiglare film or coating applied over a surface thereof.

In addition, the screen 46 can comprise a touch sensitive system, such as those disclosed previously for other embodiments of the present invention, the touch sensitive system being capable of receiving input by direct physical contact by a user's hand or stylus. In other embodiments, movement detection capabilities for the screen 46 are provided via commercially available systems like MIMIO products from VIRTUAL INK CORPORATION, USA. Such systems can comprise a transmitter stylus (not shown) and a receiver 94, as shown in FIG. 11. The movement of the stylus can be transmitted to the receiver 94 to provide input to one or more of the multimedia devices 14, as will be appreciated by those skilled in the art after reviewing this disclosure.

In yet further embodiments of the present invention, one or more of the multimedia devices 14, including, without limitation, the computer, laptop, DVD, or VCR device, are located remotely from the teaching easel 40 or 2, and are provided with wireless or hardwired links for providing signals from the multimedia devices 14 to the media center, projector 18, 18′ or speakers 8, 8′ of the teaching easel 40. Also, as will be appreciated by those skilled in the art, a plurality of communication ports can be provided for the teaching easel 40 for providing the wireless or hardwired links to the multimedia devices 14, or to a myriad of other devices and systems, including, without limitation, keyboards, mice, tablet personal computers with touch screen interfaces, video cameras, personal media systems (e.g., IPOD by APPLE COMPUTER COMPANY, U.S.A.), and external projectors.

A tablet personal computer or tablet PC 92 can be used with the present invention to remotely control and send image or audio signals to the multimedia devices 14, such as a media center. FIG. 11. The tablet PC 92 can be configured to be usable with a stylus 92′. In some embodiments of the present invention, the tablet PC 92 is in wireless communication with the media center, or other multimedia devices 14 used with the teaching easel. The tablet PC 92 can thus be used by a teacher to control the media center, or to generate text or other images and to remotely transmit the text or images to the media center 14, which can in turn be projected onto the screen 46. In this manner, a teacher can operate the teaching easel 40 remotely, such as when instructing a class while moving about a room, or stationed at fixed location away from the teaching easel 40.

Conversely, various image or audio signals can be transmitted from the teaching easel 40 to the tablet PC 92. For example, as discussed previously, user interaction with the screen 46 of the teaching easel 40 can generate input signals using a whiteboard digitizer system, such as the MIMIO system. The user-generated input from interaction with the screen 46 of the teaching easel, such as text, input selections, or images, can be transmitted to the tablet PC 92, and vice versa. In this way, a teacher may receive signals from the teaching easel 40 using the tablet PC, the signals being indicative of a student writing, drawing or selecting an input on the screen 46 of the teaching easel 40, and the teacher may transmit signals from the tablet PC to be displayed in the form of images or text on the teaching easel screen 46. This system and method can therefore provide remote interaction between teacher and an individual, through the teaching easel 40.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A teaching easel comprising:
at least one screen capable of displaying electronically generated images;
at least one conventional display board; and
at least one of a wheel and caster coupled to a wall of the teaching easel for facilitating transportation of the teaching easel, wherein each of the screen and display board are retained by at least one wall of the teaching easel by being coupled to the wall or supported by the wall.

2. The teaching easel of claim 1 furthermore comprising a camera disposed proximate a wall of the teaching easel and coupled to a support arm of the teaching easel.

3. The teaching easel of claim 1, further comprising a projector disposed within a compartment of the teaching easel.

4. The teaching easel of claim 3 further comprising reflective surfaces disposed within the compartment of the teaching easel for directing light from the projector toward a rear surface of the screen, and wherein the screen is a rear projection screen.

5. The teaching easel of claim 3 further comprising means for providing user input to a multimedia device as a function of a user touching the screen or moving an object proximate the screen.

6. The teaching easel of claim 3 further comprising a receiver coupled to the screen for receiving a signal from a transmitter usable as a stylus for drawing, selecting inputs, or writing on the screen.

7. An easel for use in presenting information to a plurality of audience members, the easel comprising:
at least one audio speaker;
at least one projection screen;
at least one multimedia device communicatively linked to the audio speaker and a projector for projecting images onto the projection screen;
at least one conventional whiteboard; and
a first camera movably coupled to a wall of the easel, wherein each of the audio speaker, projection screen, multimedia device and conventional whiteboard are coupled to or supported by a wall of the easel.

8. The easel of claim 7 further comprising a movable support arm to which the first camera is coupled.

9. The easel of claim 8 further comprising a movable support member having a surface upon which an item can be placed in visual alignment with the camera.

10. The easel of claim 7 further comprising a second camera, the second camera being retractable and disposed proximate a top portion of the easel.

11. The easel of claim 7 further comprising at least one reflective surface disposed within a compartment of the easel for reflecting an image from the projector onto the projection screen.

12. The easel of claim 7 further comprising wheels coupled to a bottom portion of the easel for transporting the easel.

13. The easel of claim 7 further comprising a slidable storage compartment that is slidable with respect to a wall of the easel.

14. A method of presenting information to an audience using a mobile easel having a screen for displaying electronically generated images, said easel also having a conventional display board coupled to a wall of the easel and a multimedia device disposed within a compartment of the easel, the method comprising:
providing a wireless link between a computer and the multimedia device of the easel;
providing an input to the computer and transmitting the input to the multimedia device; and
displaying the input on said screen.

15. The method of claim 14 wherein the computer is a tablet type personal computer having a dedicated display device and wherein providing an input to the computer comprises touching the display device of the tablet type personal computer.

16. The method of claim 15 wherein displaying the input on the screen of the easel comprises displaying text or an image written or drawn on the display device of the tablet type personal computer.

17. The method of claim 14 wherein the computer has a dedicated display device and wherein an input can be provided to the multimedia device by at least one of a user touching the screen of the easel and causing movement of an object proximate the screen of the easel and wherein said input is transmitted to the computer and displayed on a dedicated display device of the computer.

18. The method of claim 17 wherein providing input to the multimedia device by movement of an object proximate the screen of the easel comprises providing a receiver coupled to the screen and wherein the object is a stylus having a transmitter for wirelessly transmitting signals to the receiver.

19. The method of claim 14 wherein the screen is a rear projection screen and wherein the easel further comprises a projector disposed within the compartment of the easel.

20. The method of claim 14 further comprising displaying an image on the screen, said image being based on a signal received from a camera that is coupled to the easel.
